(19) United States
(12) Patent Application Publication
(10) Pub. No.: US 2021/0364359 A1
(43) Pub. Date: Nov. 25, 2021

(54) INFRARED TEMPERATURE SENSOR

(71) Applicant: ORIENTAL SYSTEM TECHNOLOGY INC., HSINCHU (TW)

(72) Inventors: Chein-Hsun WANG, Hsin-Chu (TW); Chen-Tang HUANG, Zhubei City (TW); Yu-Chih LIANG, Hsinchu City (TW); Jenping KU, Zhubei City (TW)

(21) Appl. No.: 16/924,698

(22) Filed: Jul. 9, 2020

(30) Foreign Application Priority Data
May 22, 2020 (CN) 202010440791.5

(51) Int. Cl. G01J 5/12; G01J 5/20

(52) U.S. Cl. CPC G01J 5/12; G01J 2005/0048; G01J 5/20

(57) ABSTRACT

An infrared temperature sensor comprises a thermopile sensing chip. The thermopile sensing chip includes a chip substrate, a thermopile sensing unit, a heater and a temperature sensing element. The thermopile sensing unit is disposed on the chip substrate, receives infrared thermal radiation from a target and outputs a corresponding infrared sensation signal. The heater is disposed on the chip substrate and used to heat the chip substrate to a working temperature. The temperature sensing element is disposed on the chip substrate, senses the working temperature of the chip substrate and outputs a corresponding working temperature signal. In operation, the infrared temperature sensor can maintain the thermopile sensing unit at the preset working temperature. Thereby, a single-point temperature calibration is sufficient to obtain more accurate measurement results in a broad environmental temperature range.

### BACKGROUND OF THE INVENTION

### 1. Field of the Invention

The present invention relates to a temperature sensor, particularly to an infrared temperature sensor.

### 2. Description of the Prior Art

Infrared temperature sensors, such as ear thermometers, have been widely used in non-contact temperature measurement. Infrared temperature sensors normally work at room temperature (e.g. 5° C. to 35° C.). In a conventional infrared temperature sensor, a thermopile sensing chip cooperates with a thermistor which is used to measure environmental temperature, and both are packaged inside a metallic casing, such as a TO-5 package or a TP-46 package. In general, an ear thermometer or forehead thermometer, which includes a thermopile sensing chip, should be placed still for more than 30 minutes to make the temperature of the ear thermometer or forehead thermometer identical to the temperature of the environment, whereby to acquire more accurate measurement results.

The temperature obtained by an infrared temperature sensor is the sum of the environmental temperature detected by the thermistor and the temperature difference detected by the thermopile sensing chip. The resistance-temperature table of a thermistor is only for a standard thermistor. The error of a thermistor may be a 25° C. resistance error or a Beta error of a characteristic curve. The measurement error of a thermistor occurring in a broad environmental temperature range (such as −30° C. to 50° C.) may also influence the accuracy of the measurement of an infrared temperature sensor. Therefore, the thermistor should be calibrated in multiple points to control the error within ±0.05° C.

U.S. Pat. No. 6,626,835B1 proposes a temperature sensor whose calibration process is simplified, wherein a heater heats the package casing of the thermopile sensor to maintain a constant working temperature. Based on the abovementioned design, only performing calibration at the working temperature is sufficient to make the temperature sensor accurately work at a broad environmental temperature range. It is easily understood: the package casing of the abovementioned temperature sensor needs an appropriate thermal insulting structure lest the external temperature interfere.

A China patent CN 107389206B proposes a thermopile transducer whose thermistor and thermopile sensing chip are disposed on a heater and packaged inside a package casing. However, the thermopile transducer is bulky. Further, the heat-transfer resistance between the heater and the thermistor may be different from the heat-transfer resistance between the heater and the thermopile sensing chip. Thus, temperature difference may exist between the thermistor and the thermopile sensing chip and cause measurement error.

Hence, there is a need for manufacturers to achieve a simplified calibration process of infrared temperature sensors and for the end-user to obtain accurate measurement results faster in a broad environmental temperature range.

### SUMMARY OF THE INVENTION

The present invention provides an infrared temperature sensor, wherein a thermopile sensing unit, a temperature sensing element and a heater are disposed on an identical chip substrate. The high thermal conductivity of the chip substrate keeps the thermopile sensing unit at a working temperature and decreases the temperature difference between the thermopile sensing unit and the temperature sensing element. Therefore, the infrared temperature sensor of the present invention can simplify the calibration process and obtain more accurate measurement results in a broad environmental temperature range.

In one embodiment, the infrared temperature sensor of the present invention comprises a package substrate, a thermopile sensing chip, a cap and a filter. The package substrate includes a plurality of first electric-conduction contacts and a plurality of second electric-conduction contacts electrically connected with the corresponding first electric-conduction contacts. The thermopile sensing chip is attached to the package substrate with a thermal insulation adhesive and electrically connected with the plurality of first electric-conduction contacts. The thermopile sensing chip includes a chip substrate, a first thermopile sensing unit, a heater and a temperature sensing element. The first thermopile sensing unit is disposed on the chip substrate, receiving infrared thermal radiation from a target and outputting a first infrared sensation signal corresponding to the infrared thermal radiation. The heater is disposed on the chip substrate, heating the chip substrate to a working temperature. The temperature sensing element is disposed on the chip substrate, sensing the working temperature and outputting a corresponding working temperature signal. The cap covers the thermopile sensing chip and the plurality of first electric-conduction contacts. The cap includes a window corresponding to the first thermopile sensing unit. The filter is disposed on the window of the cap, enabling the first thermopile sensing unit to receive infrared thermal radiation with a given range of wavelengths.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a diagram schematically showing a thermopile sensing chip of an infrared temperature sensor according to one embodiment of the present invention;

FIG. 2 is a diagram schematically showing an infrared temperature sensor according to one embodiment of the present invention;

FIG. 3 is a diagram schematically showing a thermopile sensing chip of an infrared temperature sensor according to another embodiment of the present invention;

FIG. 4 is a diagram schematically showing an equivalent circuit of the thermopile sensing units of the infrared temperature sensor shown in FIG. 3;

FIG. 5 is a diagram schematically showing an application of the infrared temperature sensor of the embodiment shown in FIG. 3; and

FIG. 6 is a diagram schematically showing a thermopile sensing chip of an infrared temperature sensor according to another embodiment of the present invention.

### DESCRIPTION OF THE PREFERRED EMBODIMENTS

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts of or all the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

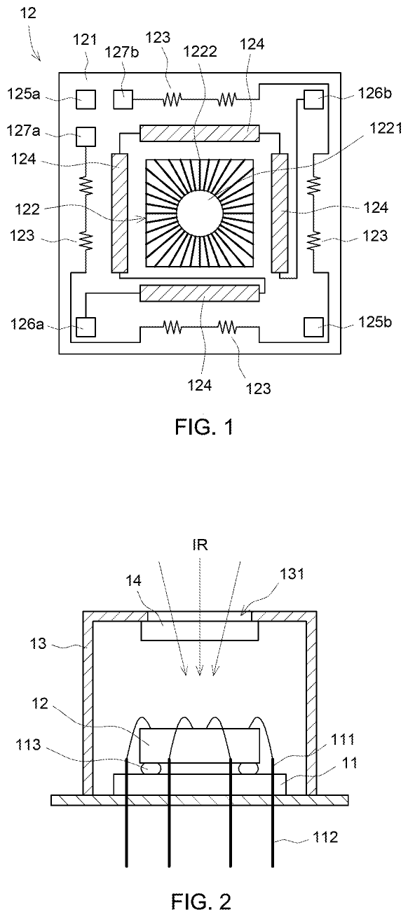

Refer to FIG. 1 and FIG. 2. In one embodiment, the infrared temperature sensor of the present invention comprises a package substrate 11, a thermopile sensing chip 12, a cap 13 and a filter 14. The package substrate 11 includes a plurality of first electric-conduction contacts 111 and a plurality of second electric-conduction contacts 112, wherein the plurality of second electric-conduction contacts 112 is electrically connected with the corresponding first electric-conduction contacts 111. For example, the package substrate 11 may be a ceramic substrate or a Bismaleimide Triazine (BT) circuit carrier board. The thermopile sensing chip 12 is attached to the package substrate 11 with a thermal insulation adhesive 113, whereby the thermal insulation adhesive 113 can prevent the external environment from thermally interfering with the thermopile sensing chip 12 through the package substrate 11. It is easily understood: the thermopile sensing chip 12 may be attached to the package substrate 11 in a measure of small-area resin dispensing to increase the heat-transfer resistance between the package substrate 11 and the thermopile sensing chip 12. The thermopile sensing chip 12 is electrically connected with the plurality of first electric-conduction contacts 111, whereby the thermopile sensing chip 12 can communicate with external circuits through the plurality of first electric-conduction contacts 111 and the plurality of second electric-conduction contacts 112 corresponding to the first electric-conduction contacts 111. In one embodiment, the thermopile sensing chip 12 may be electrically connected with the plurality of first electric-conduction contacts 111 in a wire-bonding technology. However, the present invention is not limited by the abovementioned embodiment. In one embodiment, the thermopile sensing chip 12 may also be packaged in a SMD (Surface Mounting Device) format.

The cap 13 covers the thermopile sensing chip 12 and the plurality of first electric-conduction contacts 111 so as to protect the thermopile sensing chip 12 and the plurality of first electric-conduction contacts 111. The cap 13 includes a window 131. The thermopile sensing chip 12 receives infrared thermal radiation IR from a target through the window 131. In the embodiment shown in FIG. 2, the cap 13 and a base jointly define an accommodation space to receive the package substrate 11 and the thermopile sensing chip 12. However, the present invention is not limited by the embodiment shown in FIG. 2. In one embodiment, the cap 13 is disposed on the package substrate 11 and cooperates with the package substrate 11 to define an accommodation space for receiving the thermopile sensing chip 12 and the electric connection structure of the thermopile sensing chip 12 and the plurality of first electric-conduction contacts 111. The filter 14 is disposed on the window 131 of the cap 13, making the first thermopile sensing chip 12 only able to receive infrared thermal radiation with a given range of wavelengths through the window 131.

Refer to FIG. 1 again. The thermopile sensing chip 12 includes a chip substrate 121, a first thermopile sensing unit 122, a heater 123 and at least one temperature sensing element 124. In one embodiment, the chip substrate 121 is a silicon substrate. The first thermopile sensing unit 122 is disposed on the chip substrate 121 and corresponding to the window 131 of the cap 13. The first thermopile sensing unit 122 receives infrared thermal radiation from a target through the window 131 and outputs a first infrared sensation signal corresponding to the infrared thermal radiation. In one embodiment, the first infrared sensation signal generated by the first thermopile sensing unit 122 is output to the external circuit through the electric-conduction contacts 125a and 125b. The first thermopile sensing unit 122 includes a hot end 1221 and a cold end 1222. The hot end 1221 may be realized by a floating membrane; the other end of a connection arm connected with the floating membrane functions as the cold end 1222. The detailed structure of the thermopile sensing unit is well known by the person skilled in the art and will not repeat herein.

The heater 123 is disposed on the chip substrate 121 and used to heat the chip substrate 121 to a working temperature. In one embodiment, an external circuit may power the heater 123 through the electric-conduction contacts 127a and 127b and control the working temperature of the chip substrate 121. In one embodiment, the working temperature is higher than an environmental temperature at which the infrared temperature sensor of the present invention works. For example, if the environmental temperature is 5° C. to 35° C., the heater 123 may heat the chip substrate 121 to a temperature of 50° C. to 60° C. It is easily understood: a plurality of working temperatures may be established beforehand to apply to different environmental temperatures. For example, according to the environmental temperature at which the infrared temperature sensor is operating, the heater 123 heats the chip substrate 121 to a corresponding working temperature. For example, while the environmental temperature is 0° C. to 45° C., the working temperature of the chip substrate 121 is set to be 50° C. While the environmental temperature is −20° C. to 0° C., the working temperature of the chip substrate 121 is set to be 25° C. In one embodiment, the heater 123 includes a metallic resistor (such as aluminum, tungsten or platinum) or a polysilicon resistor. In the embodiment shown in FIG. 1, the heaters 123 are arranged around the first thermopile sensing unit 122. However, the present invention is not limited by this embodiment. In other embodiments, the heaters 123 may be disposed in one side or several sides of the first thermopile sensing unit 122.

In the present invention, the temperature sensing element 124 is disposed on the chip substrate 121. In one embodiment, the temperature sensing element 124 is disposed between the first thermopile sensing unit 122 and the heater 123. In other words, the temperature sensing element 124 neighbors the heater 123 and the cold end 1222 of the first thermopile sensing unit 122. The temperature sensing element 124 detects the working temperature of the chip substrate 121, especially the working temperature of the cold end 1222 of the first thermopile sensing unit 122. Then, the temperature sensing element 124 outputs a working temperature signal. For example, the temperature sensing element 124 outputs a working temperature signal through electric-conduction contacts 126a and 126b. The temperature of a target can be calculated according to the first infrared sensation signal output by the first thermopile sensing unit 122 and the working temperature signal output by the temperature sensing element 124. In one embodiment, the temperature sensing element may include a platinum resistor, a polysilicon resistor or a thermal diode. For example, the thermal diode is formed by a base and an emitter of a bipolar transistor. In one embodiment, considering the compatibility and temperature characteristics of the semiconductor fabrication process, the thermal diode includes a plurality of Schottky diodes connected in series.

Based on the abovementioned structure, while the infrared temperature sensor of the present invention operates, the heater heats the chip substrate; via the high thermal conductivity of the chip substrate, the cold end of the thermopile sensing unit is maintained at the preset working temperature. Thus, only a single-point temperature calibration is sufficient to enable the infrared temperature sensor of the present invention to work in a broad environmental temperature range (such as −30° C. to 50° C.). Therefore, the infrared temperature sensor of the present invention can significantly simplify the calibration process. Moreover, the infrared temperature sensor of the present invention can be faster and accurately measure the temperature of a target, exempted from the interference of environmental temperature variation.

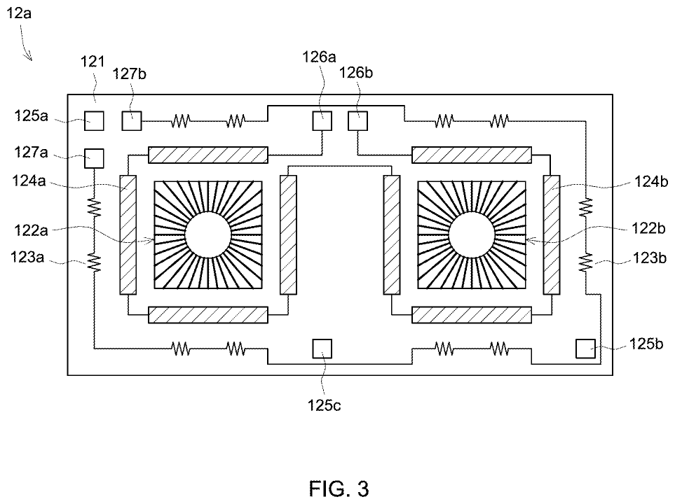

Refer to FIG. 3. The thermopile sensing chip 12a may include a plurality of thermopile sensing units 122a and 122b. Each of the thermopile sensing units 122a and 122b is equipped with corresponding heaters 123a or 123b and temperature sensing elements 124a or 124b. In one embodiment, appropriate design of the cap 13 and/or filters 14 makes the plurality of thermopile sensing units 122a and 122b may respectively receive different wavelength ranges of infrared thermal radiation through different windows 131 and filters 14, whereby to measure the temperature of a target more accurately or detect different ranges of temperatures.

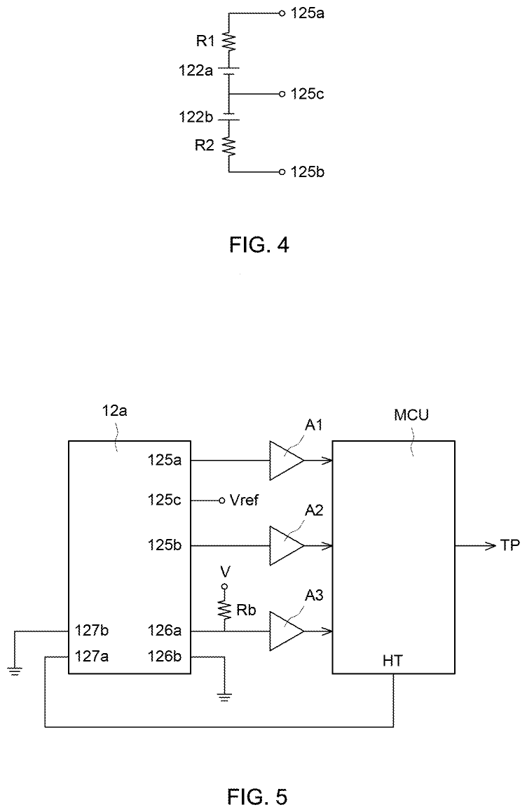

In one embodiment, one of the thermopile sensing units 122a and 122b may receive infrared thermal radiation of the cap 13, whereby to compensate for the interference caused by the infrared thermal radiation of the cap 13. For example, the thermopile sensing unit 122a is corresponding to the window 131 of the cap 13 and used as a first thermopile sensing unit to receive infrared thermal radiation of a target; the thermopile sensing unit 122b is corresponding to the cap 13 and used as a second thermopile sensing unit to receive infrared thermal radiation of the cap 13. Refer to FIG. 4, which shows an equivalent circuit of the thermopile sensing units 122a and 122b, wherein a resistor R1 is the inherent resistance of the first thermopile sensing unit (122a), and a resistor R2 is the inherent resistance of the second thermopile sensing unit (122b). In one embodiment, the second thermopile sensing unit (122b) is connected with the first thermopile sensing unit (122a) in opposite phase. If the electric-conduction contacts 125a and 125b are used to output the infrared sensation signals generated by the first thermopile sensing unit (122a) and the second thermopile sensing unit (122b), the thermal radiation effect of the cap 13 will be automatically cancelled out. Alternatively, a first infrared sensation signal generated by the first thermopile sensing unit (122a) is output from the electric-conduction contacts 125a and 125c; a second infrared sensation signal generated by the second thermopile sensing unit (122b) is output from the electric-conduction contacts 125b and 125c. In other words, the first infrared sensation signal and the second infrared sensation signal are output independently. The output infrared sensation signals are processed by external circuits to reduce the thermal radiation effect of the cap 13 and obtain more accurate measurement results due to the cap effect.

Refer to FIG. 5, which shows an application of the infrared temperature sensor of the embodiment shown in FIG. 3, wherein the thermopile sensing units 122a and 122b are respectively the first thermopile sensing unit and the second thermopile sensing unit. The infrared temperature sensor of the present invention is electrically connected with a microcontroller MCU through amplifiers A1, A2 and A3. The temperature sensing elements 124a and 124b are connected to a bias voltage V and a bias resistor Rb through the electric-conduction contact 126a and output the working temperature signals to the amplifier A3. The working temperature signals are buffered and amplified and then fed into the microcontroller MCU. The microcontroller MCU compares the working temperature with a preset value and then controls the heaters 123a and 123b through an IO Port HT or a NMOS driver, which is electrically connected with the electric-conduction contact 127a, to heat the cold ends of the thermopile sensing units 122a and 122b to the working temperature.

In measurement, the first infrared sensation signal generated by the first thermopile sensing unit (122a) is output to the amplifier A1 through the electric-conduction contacts 125a and 125c. Next, the first infrared sensation signal is buffered and amplified and then fed into the microcontroller MCU. Similarly, the second infrared sensation signal generated by the second thermopile sensing unit (122b) is output to the amplifier A2 through the electric-conduction contacts 125b and 125c. Next, the second infrared sensation signal is buffered and amplified and then fed into the microcontroller MCU. The electric-conduction contact 125c is connected with a reference voltage Vref. According to the first infrared sensation signal generated by the first thermopile sensing unit (122a), the second infrared sensation signal generated by the second thermopile sensing unit (122b), and the working temperature signals generated by the temperature sensing elements 124a and 124b, the microcontroller MCU works out the measurement temperature TP of the target and then outputs the measurement temperature TP.

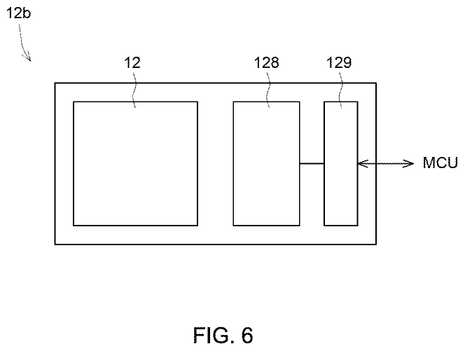

Refer to FIG. 6. In one embodiment, the thermopile sensing chip 12b further includes a non-volatile memory 128 and a communication interface 129 in addition to the structure of the thermopile sensing chip 12 shown in FIG. 1. The non-volatile memory 128 may record characteristic parameters of the first thermopile sensing unit and corresponding working temperatures. In one embodiment, the non-volatile memory 128 may be a Multiple-Times Programmable (MTP) memory or a One-Time Programmable (OTP) memory. For example, the MTP memory may be a flash memory or an Electrically-Erasable Programmable Read-Only Memory (EEPROM). The communication interface 129 is electrically connected with the non-volatile memory 128, enabling an external circuit to access the non-volatile memory 128. For example, the microcontroller MCU may access the non-volatile memory 128 through the communication interface 129. In one embodiment, the communication interface 129 may be an Inter-Integrated Circuit (I²C) Bus, a Universal Asynchronous Receiver/Transmitter (UART), a Serial Peripheral Interface (SPI), or a Universal Serial Bus (USB), or an analog voltage-type or logic input/output. In one embodiment, the thermopile sensing chip 12, the non-volatile memory 128 and the communication interface 129 may be disposed in a single chip substrate. Alternatively, the non-volatile memory 128 and the communication interface 129 are independent chips, packaged inside the infrared temperature sensor of the present invention.

In one embodiment, the infrared temperature sensor of the present invention is calibrated based on wafer-level temperature calibration set up to obtain the characteristic parameters of the temperature sensing element. In the wafer-level temperature calibration set up, the entire wafer, including the probe stage, is placed in a temperature-controlled environment during test. For example, the sucking disc of the wafer stage may be equipped with water piping to control the temperature of the wafer, whereby to simulate specified temperature environments and obtain the required characteristic temperature parameters of temperature sensor. Thereby, the infrared temperature sensor can be automatically calibrated and thus greatly save the cost and time of calibration. It is easily understood: the test platform can store the characteristic parameters obtained during test to the non-volatile memory through the communication interface, whereby the succeeding calibration process of the infrared temperature sensor can be omitted.

In conclusion, the present invention provides an infrared temperature sensor, wherein a thermopile sensing unit, a temperature sensing element and a heater are disposed in an identical chip substrate, whereby to maintain the thermopile sensing unit at a working temperature during operation and decrease the temperature difference between the thermopile sensing unit and the temperature sensing element. Thus, the calibration of the infrared temperature sensor of the present invention can be completed in a single-point temperature calibration. Further, the present invention can facilitate a wafer-level temperature calibration. Furthermore, the infrared temperature sensor of the present invention can be faster (without long stabilization time) and more accurately obtain the measurement results within a broad environmental temperature range.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the appended claims.

What is claimed is:

1. An infrared temperature sensor, comprising:
a package substrate, including a plurality of first electric-conduction contacts and a plurality of second electric-conduction contacts electrically connected with the corresponding first electric-conduction contacts;
a thermopile sensing chip, attached to the package substrate with a thermal insulation adhesive and electrically connected with the plurality of first electric-conduction contacts, wherein the thermopile sensing chip includes:
a chip substrate;
a first thermopile sensing unit, disposed on the chip substrate, receiving infrared thermal radiation from a target and outputting a corresponding first infrared sensation signal;
a heater, disposed on the chip substrate, heating the chip substrate to a working temperature; and
a temperature sensing element, disposed on the chip substrate, sensing the working temperature and outputting a corresponding working temperature signal;
a cap, covering the thermopile sensing chip and the plurality of first electric-conduction contacts, wherein the cap includes a window corresponding to the first thermopile sensing unit; and
a filter, disposed on the window of the cap, enabling the first thermopile sensing unit to receive infrared thermal radiation with a given range of wavelengths.

2. The infrared temperature sensor according to claim 1, wherein the temperature sensing element includes a platinum resistor, a polysilicon resistor or a thermal diode.

3. The infrared temperature sensor according to claim 2, wherein the thermal diode is formed by a base and an emitter of a bipolar transistor.

4. The infrared temperature sensor according to claim 2, wherein the thermal diode includes a plurality of Schottky diodes connected in series.

5. The infrared temperature sensor according to claim 1, wherein the heater includes a metallic resistor or a polysilicon resistor.

6. The infrared temperature sensor according to claim 1, wherein the heater is arranged around the first thermopile sensing unit to control a cold end of the first thermopile sensing unit to the working temperature.

7. The infrared temperature sensor according to claim 1, wherein the temperature sensing element is disposed between the first thermopile sensing unit and the heater.

8. The infrared temperature sensor according to claim 1, wherein the chip substrate is a silicon substrate.

9. The infrared temperature sensor according to claim 1, wherein the working temperature is higher than a temperature of an environment where the infrared temperature sensor operates.

10. The infrared temperature sensor according to claim 1, wherein the working temperature ranges from 50° C. to 60° C.

11. The infrared temperature sensor according to claim 1, wherein a plurality of the working temperatures is established; according to a temperature of an environment where the infrared temperature sensor operates, the heater heats the chip substrate to the working temperature corresponding to the temperature of the environment.

12. The infrared temperature sensor according to claim 1, wherein the thermopile sensing chip includes a plurality of the first thermopile sensing units and the plurality of first thermopile sensing units respectively receives infrared thermal radiations with different ranges of wavelengths.

13. The infrared temperature sensor according to claim 1, wherein the thermopile sensing chip further includes a second thermopile sensing unit, which is corresponding to the cap and receives infrared thermal radiation from the cover.

14. The infrared temperature sensor according to claim 13, wherein the second thermopile sensing unit is connected with the first thermopile sensing unit in opposite phase; or the second thermopile sensing unit outputs a corresponding second infrared sensation signal independently.

15. The infrared temperature sensor according to claim 1, wherein the thermopile sensing chip further includes:
a non-volatile memory, recording a characteristic parameter of at least one of the first thermopile sensing unit and the temperature sensing element and the corresponding working temperatures; and
a communication interface, electrically connected with the non-volatile memory, and enabling an external circuit to access the non-volatile memory through the communication interface.

16. The infrared temperature sensor according to claim 15, wherein the non-volatile memory includes a Multiple-Times Programmable (MTP) memory or a One-Time Programmable (OTP) memory.

17. The infrared temperature sensor according to claim 15, wherein the non-volatile memory includes a flash memory or an Electrically-Erasable Programmable Read-Only Memory (EEPROM).

18. The infrared temperature sensor according to claim 1, wherein a characteristic parameter of the temperature sensing element is obtained with a wafer-level temperature calibration set up.
